(19) United States
(12) Patent Application Publication
(10) Pub. No.: US 2017/0213175 A1
(43) Pub. Date: Jul. 27, 2017

(54) SYSTEMS AND METHODS FOR EVENT MANAGEMENT IN ENTERPRISE RESOURCE PLANNING SYSTEMS

(71) Applicant: Velocity Technology Solutions, Inc., New York, NY (US)

(72) Inventors: Pritesh Prabhakar Gaikwad, Pune (IN); Rahul V. Gujarathi, Pune (IN); Bhupendra Ramdeen Jhade, Pune (IN); Rishikesh D. Kashid, Pune (IN); Ashu Mahajan, Pune (IN); Bhushan Pitambar Patil, Pune (IN); Reshma Pandurang Patil, Pune (IN); Khanderao R. Sarang, Pune (IN); Thomas Mac Kremer, Minneapolis, MN (US); August Jean Mockenhaupt, Minneapolis, MN (US); Paul Andrew Mockenhaupt, Minneapolis, MN (US); Travis Noel Tuttle, Minneapolis, MN (US); John Robert Waite, Minneapolis, MN (US); Chen-Feng Yang, Minneapolis, MN (US)

(21) Appl. No.: 15/414,467

(22) Filed: Jan. 24, 2017

Related U.S. Application Data
(60) Provisional application No. 62/286,809, filed on Jan. 25, 2016.

(51) Int. Cl. G06Q 10/06

(52) U.S. Cl. CPC G06Q 10/06315

(57) ABSTRACT

The system and methods described herein monitor transactions occurring in any large complex enterprise software systems for simple or compound events that meet certain defined rules. Once events occur that successfully meet the criteria set out in each rule, then proactive notifications are sent to designated users. This enables early detection of suspicious transactions and also quick response in real-time.

### CROSS-REFERENCE To RELATED APPLICATIONS

This application claims priority to U.S. Provisional Application Ser. No. 62/286,809 filed on Jan. 25, 2016, which is hereby incorporated by reference in its entirety.

### TECHNICAL FIELD

The present disclosure relates in general to systems and methods for managing enterprise information on a distributed computer system, and more specifically to systems and methods for monitoring of occurrence of certain events conforming to certain defined rules in one or more enterprise resource planning (ERP) systems and providing appropriate notifications.

### BACKGROUND

ERP systems often include software solutions that integrate information and processes within and across different areas of an organization. In this way enterprise-wide information can be viewed and enterprise-wide decisions may be made and implemented. ERP systems are associated with massive volumes of data. In ERP systems, information from users, customers, managers, and other stakeholders is continuously generated, collected, and processed. Continual tracking of all the various elements and their associated data within an organization can be overwhelming. Problems with users and systems are analyzed by querying information from a database and viewing reports or displaying results from queries on digital dashboards or running audits to detect anomalies from standard performance. But these processes lead to delays in analyzing incidents and missed training opportunities, and when the incidents are threats to the infrastructure or system, these delays can be costly in terms of financial and human resources.

### SUMMARY

Disclosed herein are systems and methods addressing the shortcomings of the art, and may provide any number of additional advantages, such as increasing productivity, reducing delay in detection and handling of threats, dynamically scale systems to address real time workload changes, proactively alert based on trends in response time degradation, offering real-time training, and acquiring a competitive business advantage. The system and methods described herein provide notifications of events that occur in the ERP system and satisfy certain user-defined rules.

Certain embodiments include a method of detecting events in an enterprise resource planning system. The method includes receiving, by a server, from an authorized device of an enterprise resource planning system a plurality of criteria defining a rule and stored as a first plurality of records in an event management database, wherein the plurality of criteria were selected by a user via a graphical user interface in a rule composition graphical user interface that presents transaction, batch, and access each as a rule type option, and name, operator and value as the plurality of criteria and receiving, by the server, a plurality of information associated with a first plurality of events occurring at a plurality of user devices in the enterprise resource planning system. Further the method comprises filtering, by the server, the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule and retrieving, by the server, from the event management database in response to identifying the second plurality of events a second plurality of records defining a notification profile associated with the rule, wherein the notification profile includes one or more preferences for notification format, and one or more designated recipient devices. Finally, the method includes formatting, by the server, the one or more of the plurality of information associated with the second plurality of events to generate one or more notifications based on the notification profile and transmitting, by the server, the one or more notifications to the one or more designated recipient devices to present a first notification of the one or more notifications via the graphical user interface wherein the first notification includes a date, the rule, and event details for each event of the second plurality of events, wherein selecting the event details presents an event details graphical user interface.

Certain embodiments include a system for detecting events in an enterprise resource planning system. The system includes an event management database and a processor communicatively coupled to the event management database. The processor may be configured to receive from an authorized device of an enterprise resource planning system a plurality of criteria defining a rule and stored as a first plurality of records in an event management database, wherein the plurality of criteria were selected by a user via a graphical user interface in a rule composition graphical user interface that presents transaction, batch, and access each as a rule type option, and name, operator and value as the plurality of criteria and receive a plurality of information associated with a first plurality of events occurring at a plurality of user devices in the enterprise resource planning system. The processor may be further configured to filter the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule and retrieve from the event management database in response to identifying the second plurality of events a second plurality of records defining a notification profile associated with the rule, wherein the notification profile includes one or more preferences for notification format, and one or more designated recipient devices. The processor may finally be configured to format the one or more of the plurality of information associated with the second plurality of events to generate one or more notifications based on the notification profile and transmit the one or more notifications to the one or more designated recipient devices to present a first notification of the one or more notifications via the graphical user interface wherein the first notification includes a date, the rule, and event details for each event of the second plurality of events, wherein selecting the event details presents an event details graphical user interface.

Numerous other aspects, features and benefits of the present disclosure may be made apparent from the following detailed description taken together with the drawing figures. The systems can include less components, more components, or different components depending on desired analysis goals. It should be further understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale. The emphasis is instead placed upon illustrating the principles of the disclosure. In the figures, reference numerals designate corresponding parts throughout the different views.

FIG. 1 is a block diagram illustrating a system including an event management engine within an ERP system, according to an embodiment.

FIG. 2 is a flowchart showing an exemplary process for the flow of information through modules of an event management system for receiving events and sending notifications.

FIG. 3 is a flowchart showing an exemplary process for creating rules using the event management system, according to an embodiment.

FIG. 4 is a flowchart showing an exemplary process for updating rules, according to an embodiment.

FIG. 5A is an illustrative user interface for managing rules, according to an exemplary embodiment.

FIG. 5B is an illustrative user interface for deleting an existing rule, according to an exemplary embodiment.

FIG. 6 is an illustrative user interface that is presented to a user to create new rules, according to an exemplary embodiment.

FIG. 7 is an illustrative user interface of a notification inbox, according to an exemplary embodiment.

FIG. 8 is an illustrative user interface showing details of events that have triggered notification, according to an exemplary embodiment

FIG. 9 is an illustrative class diagram presenting a high level view of the different software modules/packages that collectively perform the event management functions, according to an exemplary embodiment.

FIGS. 10A and 10B form a continuous flowchart illustrating an event management process, according to an exemplary embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of embodiments.

As used here, the following terms may have the following definitions:

An “event” refers to an occurrence of a transaction that matches certain criteria. A simple event is a one-time occurrence that matches certain criteria. Examples of simple events, without limitations, include a user named Chris logging into the system successfully, an employee attempting benefit enrollment from his desk, an employee attempting to login at a computer at Best Buy, or a clerk at the general ledger department receiving security errors while trying to view human resource data.

A compound event includes multiple occurrences of simple events, and in certain embodiments, the complex events may include Time-Box and Index functionalities.

“Time boxing,” as used herein, refers to the addition of a time criteria to trigger notification based on complex events. Time boxing allows users create to create rules for notification following multiple occurrences of simple events. Examples, without limitations, include five or more transactions in the accounts payable system with a response time of more than 2 seconds within a one-minute period, ten or more unsuccessful login attempts occurring from Eastern Europe within a five-minute period, and two batch jobs in the human resources queue having gone into a “needs recovery” status within that last hour.

“Indexing,” further extends Time Boxing by allowing these time boxed events to be grouped by additional criteria. Examples, without limitations, include any individual user in the accounts payable system that gets the same error on the invoice application five times within a five minute period, or any human resources clerk that views more than ten employee master records within an hour.

An “event management engine” refers to one or more software modules that handle data, execute rules, and perform data matching by using appropriate logic, including but not limited to software that monitor any of the ERP systems for simple or compound events and provide proactive notifications to designated or authorized parties.

Certain embodiments include early exposure of events that are pervasive within the ERP systems. The event management system consists of an event management engine, which provides a rule composer module for defining rules, and a notification module to send alerts via a browser, app, email, or text message.

Certain embodiments include a method of detecting events in an enterprise resource planning system. The method includes receiving, by an event management engine, from an authorized device of an enterprise resource planning system a plurality of criteria defining a rule and stored as a first plurality of records in an event management database; receiving a plurality of information associated with a first plurality of events occurring at a plurality of user devices in the enterprise resource planning system; filtering the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule; retrieving from the event management database in response to identifying the second plurality of events a second plurality of records defining a notification profile associated with the rule, wherein the notification profile includes one or more preferences for notification format, one or more designated recipient devices, and a notification schedule; formatting the one or more of the plurality of information associated with the second plurality of events to generate one or more notifications based on the notification profile; and transmitting the one or more notifications over an electronic communication network to user interfaces of the one or more designated recipient devices according to the notification schedule. The notification can be a text message. The notification can be an electronic mail.

Certain embodiments include a system for detecting events in an enterprise resource planning system. The system includes an event management database; one or more processors communicatively coupled to the event management databases; and non-transitory computer-readable medium positioned in communication with the one or more processors and having computer program stored thereon including a set of instructions. These instructions when executed by one or more processors cause the one or more processors to perform operations of receiving, by an event management engine, from an authorized device of an enterprise resource planning system a plurality of criteria defining a rule and stored as a first plurality of records in an event management database; receiving a plurality of information associated with a first plurality of events occurring at a plurality of user devices in the enterprise resource planning system; filtering the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule; retrieving from the event management database in response to identifying the second plurality of events a second plurality of records defining a notification profile associated with the rule, wherein the notification profile includes one or more preferences for notification format, one or more designated recipient devices, and a notification schedule; formatting the one or more of the plurality of information associated with the second plurality of events to generate one or more notifications based on the notification profile; and transmitting the one or more notifications over an electronic communication network to user interfaces of the one or more designated recipient devices according to the notification schedule.

The event management system can empower businesses to detect fraud, reduce risk, improve compliance, and improve human productivity by proactively managing events in the ERP system. Businesses cannot afford the consequences of a data breach, revenue loss, or simply inefficient processes. The proactive notifications and on-demand reporting features of the event management system allows decision-makers to identify and respond in real-time to events that have been determined to be critical to the success of a particular team, department, or the organization. The event management system may function as part of comprehensive fraud detection program, as authorized users can create simple or compound event alerts, monitor user access and errors, and be notified upon the occurrence of simple or compound events, thereby identifying and isolating a threat by defined criteria. Authorized users may also tap into rule-based pattern recognition features of the event management system to alert decision-makers to rapidly identify, track, and investigate potentially harmful events, and minimize both threat and response time. The event management system can also be designed to alert a systems manager when an employee has certain number of login errors consecutively within a designated amount of time. The event management system can additionally be used to trigger additional infrastructure to be provisioned to improve user experience or alert administrator of degradation in performance.

The event management system provides complete flexibility in creating notifications for any event occurring in the ERP system. Using event management system, authorized users or teams may receive real-time alerts and specialized views to devices of choice. Designated or authorized individuals/teams may create and customize simple or compound rules and alerts in the event management system as required to meet their needs. These alerts and notifications may be customized in formats, such as reports, for designated individuals within the company. The event management system may provide more detailed alerts to certain designated or authorized individuals or teams, such as including pertinent ERP data providing ability for immediate action.

The event management system may be configured to deliver real-time, on-demand and at-a-glance notifications. These notifications can confirm with real-time data any perceptions of performance issues within a system or regarding an individual, and thus minimize response time and potential data loss. The event management system can be configured to optimize workflow and batch jobs with alerts on failed or delayed computing. Another advantage of real-time notifications using the event management system lies in maximizing training opportunities based on customizable human interaction with the system, therefore a user having issues can be identified and corrective responses can be undertaken close to the occurrence of the issues. Critical trends that can hinder process execution and efficiency, such as a high volume of incorrect orders from a specific client can be addressed with minimal loss of time and effort.

The event management system can be configured to apply rules to data to and from other organizational systems that are communicatively coupled to the ERP systems, including but not limited to supply chain management systems or customer relationship managements. In certain embodiments, the event management system can be deployed as part of an enterprise application integration middleware. Designated or authorized individuals or teams can define and implement any relevant business rules and criteria for identifying events or notifying users, and this can be applied to data values across all information systems. The event management system can be applied to raw data or cleansed data or enriched data from within the ERP systems and across all information systems.

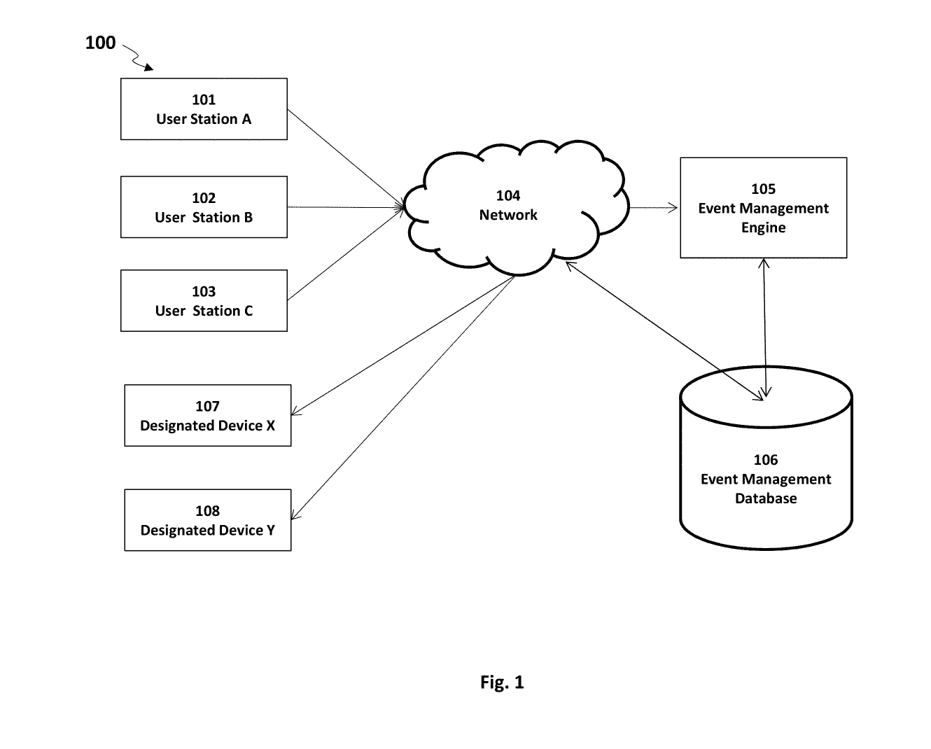

FIG. 1 is a block diagram illustrating a system including an event management engine within an ERP system, according to an embodiment. The plurality of steps included in methods described above may be performed by one or more computing devices such as, for example, the system described in 100. Each of the different components of event management system 100 may be implemented in any type of computer-based architecture including suitable processor-controlled devices that receive, process, and/or transmit digital data, configured as described above. Examples of devices incorporating one or more suitable processor-controlled devices include smartphones, desktop computers, laptop computers, servers, tablets, PDAs, and specialized computing platforms performing enterprise data processing, rule matching and notification algorithms, and the like.

In certain embodiments, users 1, 2, and 3 at computing devices illustrated as User Station A 101, User Station B 102, and User Station C 103 perform one or more transactions in the ERP system of an organization and interact via network 104 with the event management engine 105. One or more of the user stations can be an authorized user station or can be accessed by an authorized user to create rules for the detection and management of events. The event management engine 105 may be implemented as software that runs on a server including a processing unit for running related algorithms or computer executable program instructions. The event management engine 105 may be implemented using a single-processor system including one processor, or a multi-processor system including any number of suitable processors that may be employed to provide for parallel and/or sequential execution of one or more portions of the techniques described herein. Processes and logic flows described herein may be performed by one or more programmable processors executing one or more computer programs to perform functions by operating on input data and generating corresponding output. Processing unit may include a processor with computer-readable medium, such as a random access memory (RAM) (not shown) coupled to the processor. Examples of processor may include a microprocessor, application specific integrated circuit (ASIC), and field programmable object array (FPOA), among others.

In some embodiments, event management engine 105 can be implemented as part of a server, a user computing device and the like. Examples of suitable implementations of the event management engine 105 include servers, authorized user computing devices, smartphones, desktop computers, laptop computers, tablet computers, PDAs and other types of processor-controlled devices that receive, process, and/or transmit digital data. In an example, event management engine 105 performs certain operations that are required for the proper operation of system architecture 100. Suitable event management engine 105 performs these operations as a result of central processing unit executing software instructions contained within a computer-readable medium, such as within memory. In one embodiment, the software instructions of the system are read into memory associated with the event management engine 105 from another memory location, such as from a storage device, or from another computing device via a communication interface. In this embodiment, the software instructions contained within memory instruct the event management engine 105 to perform processes described above. Alternatively, hardwired circuitry may be used in place of or in combination with software instructions to implement the processes described herein. Thus, implementations described herein are not limited to any specific combinations of hardware circuitry and software.

The event management engine 105 is communicatively coupled to the event management database 106. In one or more embodiments, event management database 106 contains the data from the ERP systems, including but not limited to data from accounting and finance, human resources, manufacturing, inventory control, sales and marketing, purchasing, warehouses, shipping, and other logistics groups.

The event management database 106 may be configured as a combination of external sources and internal databases, and is implemented as relational databases that provide functions of fetching, indexing, and storing data. In these embodiments, event management database 106 provides aforementioned data and other stored data and files to one or more software modules within event management system 100 for further analysis. Examples of data received from external sources include inventory management, sales, customer interaction, and financial records. The event management database 106 may be implemented through database management systems (DBMS), such as, MySQL, PostgreSQL, SQLite, Microsoft SQL Server, Microsoft Access, Oracle, SAP, dBASE, FoxPro, IBM DB2, LibreOffice Base, FileMaker Pro, and/or any other type of database that may organize collections of data. In these embodiments, event management database 106 may be implemented using application protocols for accessing and maintaining distributed directory information services or data feeds such as, for example, Lightweight Directory Access Control (LDAP), among others. Data stored in fields of the databases may be updated as needed, for example, by a user with administrative access to the database to add new data to the libraries in the database as they become supported. It will be appreciated by those having skill in the art that data described herein as being stored in the databases may also be stored or maintained in non-transitory memory and accessed among subroutines, functions, modules, objects, program products, or processes, for example, according to objects and/or variables of such subroutines, functions, modules, objects, program products or processes. Any of the fields of the records, tables, libraries, and so on of the database may be multi-dimensional structures resembling an array or matrix and may include values or references to other fields, records, tables, or libraries. Any of the foregoing fields may contain either actual values or a link, a join, a reference, or a pointer to other local or remote sources for such values. External sources may be, for example, a single database, multiple databases, or a virtual database, including data from multiple sources, for example, servers on the World Wide Web.

The electronic communications network 104 may comprise any communication architecture including devices and software that facilitates communication between a transmitter and a receiver residing in one or more computing devices that form system 100. It should also be obvious to one skilled in the art that the network components may be implemented in dedicated processing equipment, and/or in a cloud processing network. The network 104 may be made up of an intranet, a local area network (LAN), cloud networks, virtual private networks (VPN), wireless area networks (WAN), and the internet, or any other network that enables servers and user devices to interact with one another. Non-limiting examples of devices comprising the network may include routers, switches, hubs, firewalls, proxy servers, telecommunications trunks, and the like. Accordingly, the electronic communications network can be implemented, in whole or in part, over a wireless or a wired communications network or combination of both. In addition, according to various exemplary embodiments of the present invention, the wireless communications network can be implemented over any of various wireless communication technologies, for example: code division multiplexed access (“CDMA”), global system for mobile communications (“GSM”), and wireless local area network such as WiFi, World Interoperability for Microwave Access (“WiMAX”), or Bluetooth®.

The event management engine 105 may generate user interfaces on computing devices, including user devices 101, 102, and 103 and designated recipient devices 107 and 108. Such devices are communicatively coupled to and in bi-directional communication with other devices, databases, and components of the event management system 100. Computing devices, including user devices 101, 102, and 103 and designated recipient devices 107 and 108, may be a laptop computer or a desktop computer, or a mobile computing device such as a smart phone, a cell phone, a tablet, a personal digital assistant (PDA), a mobile computer with a smart phone client, or any other data access-enabled device. The designated recipient devices 107 and 108 are configured to receive notifications from the event management engine 105. The event management engine 105 utilizes the user interfaces to request, collect, and present information from and to one or more of the users. The users may interact with the user interface via an input/output (I/O) device such as a touch screen, a mouse, a keyboard and/or a keypad working in concert with a display, and others. In some embodiments, data processing modules of the event management engine 105 are further configured to automatically retrieve information requested by one or more computing devices 101, 102, and 103 and designated recipient devices 107 and 108, or one or more software modules. In these embodiments, this information is obtained from event management database 106. In other embodiments this information is obtained from the operation of one or more software modules within the ERP system. The event management engine 105 may include and/or be communicatively coupled to software module(s), including but not limited to one or more audit modules, rule executor modules, alert and notification modules, document management modules, and administration modules. In one or more embodiments, the event management engine 105 may interact with external services, applications, and databases through one or more application programming interfaces (API), an RSS feed, or some other structured format. The API may be a Representational State Transfer Application Programming Interface (REST API) that controls and manages one or more APIs. In these embodiments, the API may provide web services to one or more mobile applications installed on the computing devices. Examples of web services include displaying data on a website, uploading large amounts of data that will later be consumed by a mobile app, downloading data to run custom analytics, exporting data, and the like.

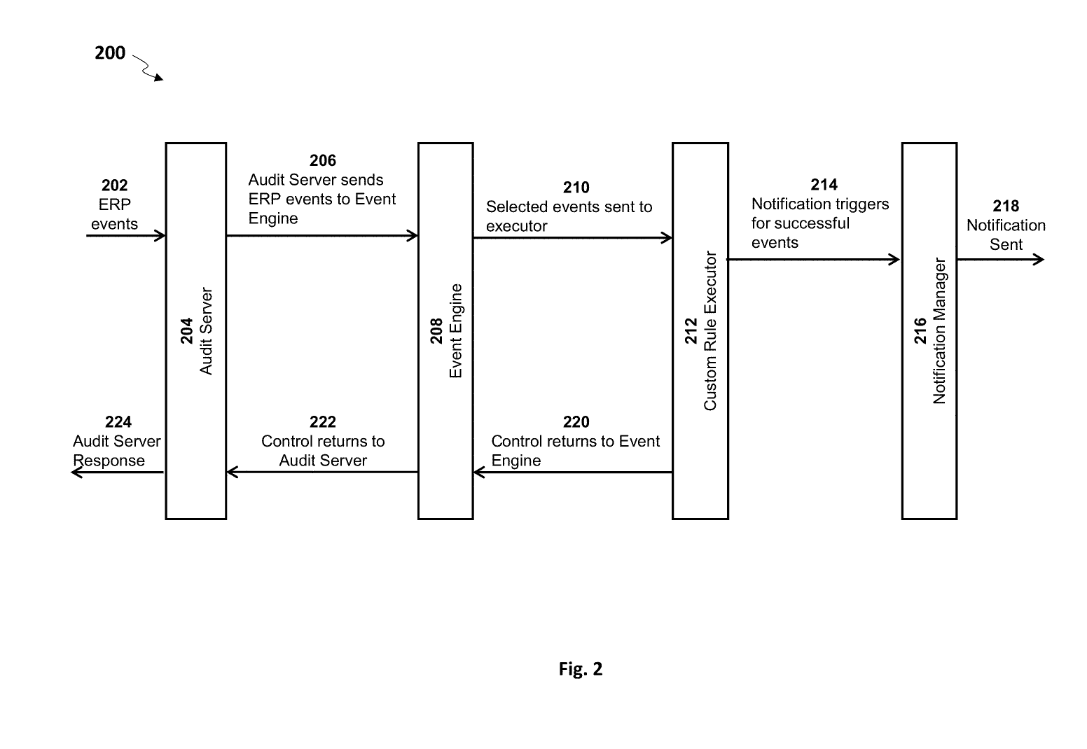

FIG. 2 is a flowchart showing an exemplary process 200 for the flow of information through modules of an event management system for sending notifications. In step 202, ERP events may be sent to an auditor module 204 that provides records associated with the event, such as event metadata, to the event management database. In a next step 206, the ERP events may be sent to an event engine 208 that selects events applicable for implementing rules. Next, in step 210, the event engine 208 may send the selected events to a custom rule executor 212 that evaluates events against the criteria set in the rules provided by an authorized user. Next, in step 214, notifications may be triggered by the custom rule executor 212 for events that successfully meet the criteria and are sent to the notification manager 216. In a next step 218, the notification manager 216 may send alerts in a preferred format to a preferred device of a designated recipient. The notification manager 216 may be configured to send alerts in different formats, such as texts, e-mail, app notifications, web hyperlinks, for example, to one or more devices. The devices may include smartphones, tablets, and other computing and communication devices. Next in step 220, the custom rule executor 212 may control returns to the event engine 208. In step 222, the event engine 208 may control returns to the auditor module 204, which may then generate an audit server response 224.

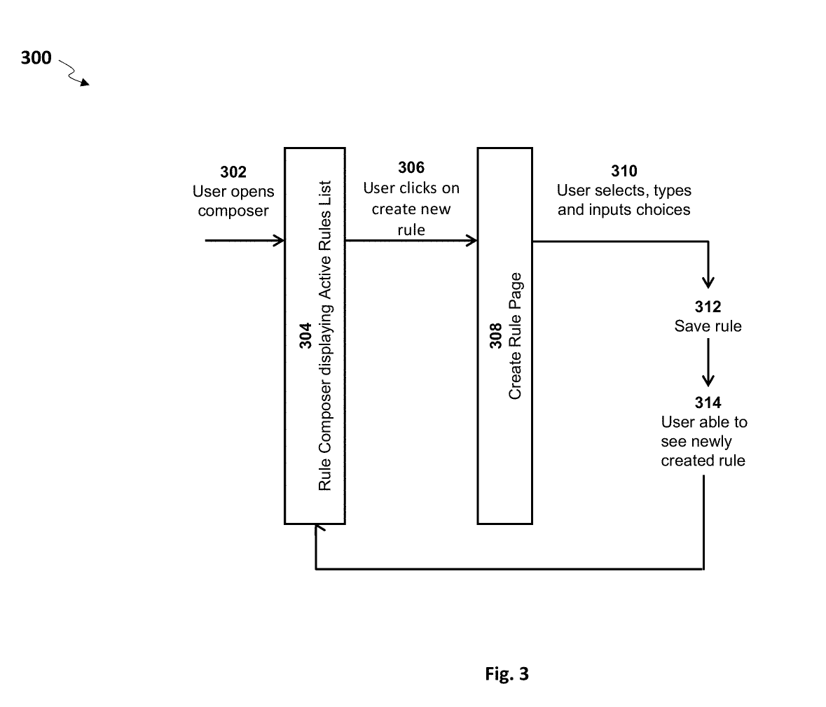

FIG. 3 is a flowchart showing an exemplary process 300 for creating rules using the event management system. In a first step 302, the user may log in using a user device, and open the rule composer 304. In some embodiments, rule composer 304 comprises a user interface allowing the user to compose rules and also view existing rules. When the user chooses to create a new rule in a next step 306, the user may be directed to “Create New Rule” page 308. In create new rule page 308 the user is presented with different options for creating rules. For example, rules for certain transactions may be created as well as rules for batches of data, or rules for an individual user or group of users. After the user selects one of the available options for the type of rule in step 310, the user may be directed to a rule criteria page. The user further may select one or more criteria and the criteria operator, and input the criteria value. The user is then directed to a notification management page. On the notification management page, the user can include additional constraints such as time boxing configurations and add the list of designated users to receive the notifications and move onto next steps or be otherwise directed to a finish page. At this interface, the user can name the newly created rule and add a short description for other users. The user is then directed to save the rule as in step 312, and review one or more features as in step 314. The newly created rule can also be presented as the set of rules available at the rule composer 304.

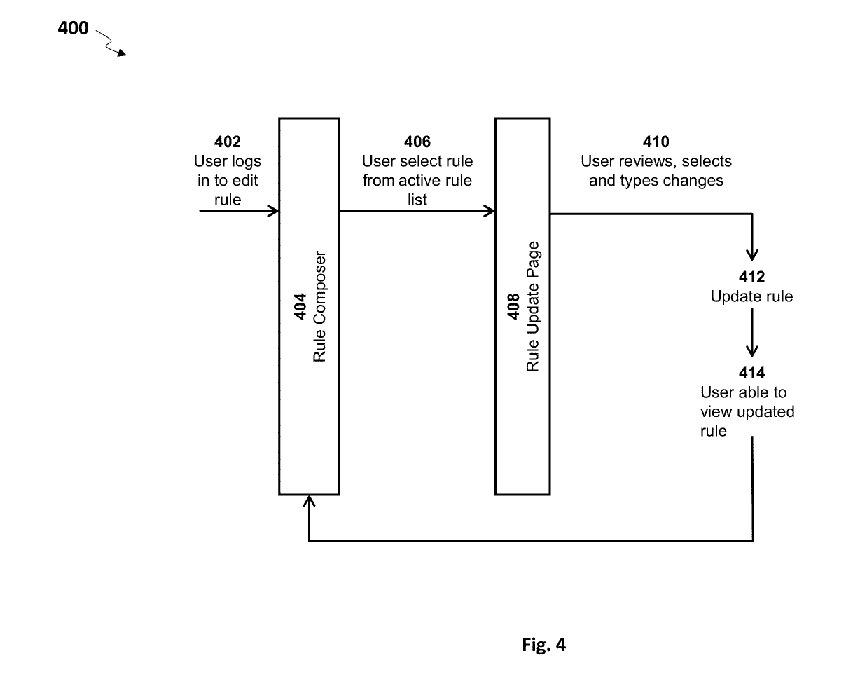

FIG. 4 is a flowchart showing an exemplary process 400 for updating rules. In step 402 the user may open rule composer 404. Rule composer 404 may comprise a graphical user interface allowing the user to view existing rules, and choose a rule to modify/update. The user may choose to view the criteria associated with the rule next in step 406. The user may then be directed to a rule criteria page. On rule update page 408, the user may review or revise one or more criteria, select or revise the criteria operator, and input or revise the criteria value as needed in step 410. The user may then be directed to a grouping and user page. On the grouping and user page, the user may revise or add additional constraints such as time boxing configurations. Similarly the user may revise and/or add individuals to the list of designated recipients to receive the notifications and move onto the next steps, or otherwise be directed to a finish page. On this interface, the user may revise the name of the updated rule and add a short description regarding the updated rule for other users. The user may then be directed to save the rule in step 412, and review one or more features of the updated rule in step 414. The updated rule may also be presented as the set of rules available at the rule composer 404.

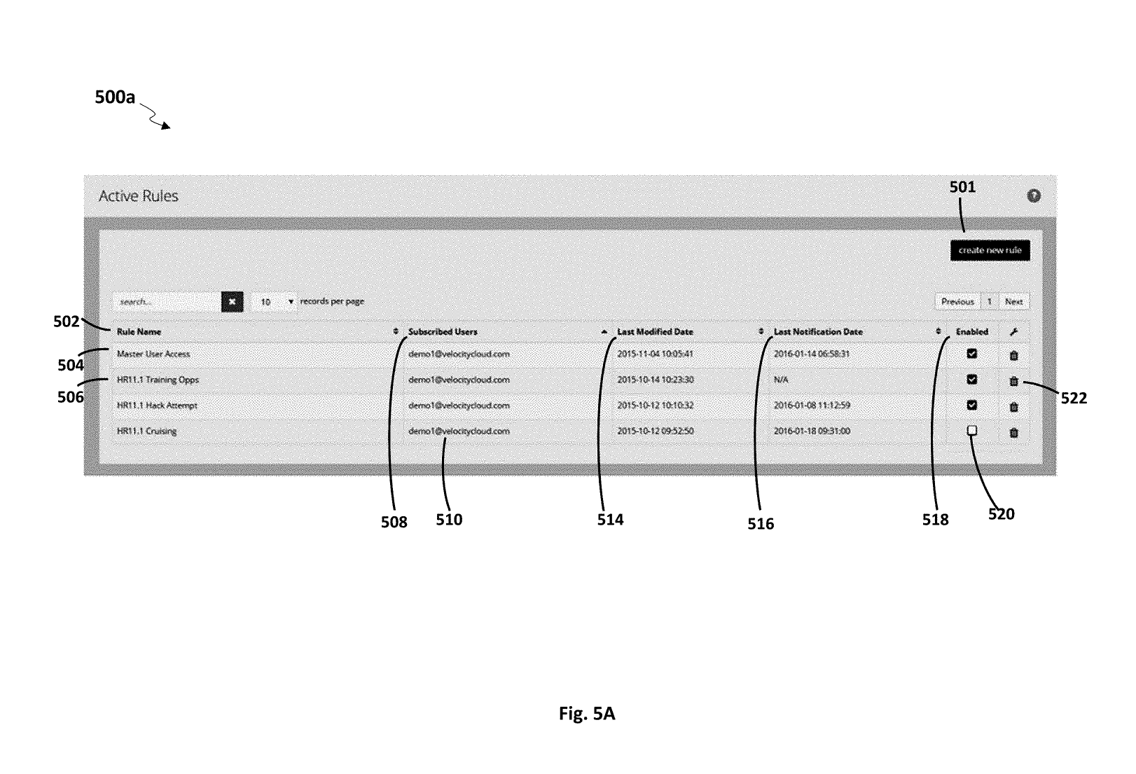

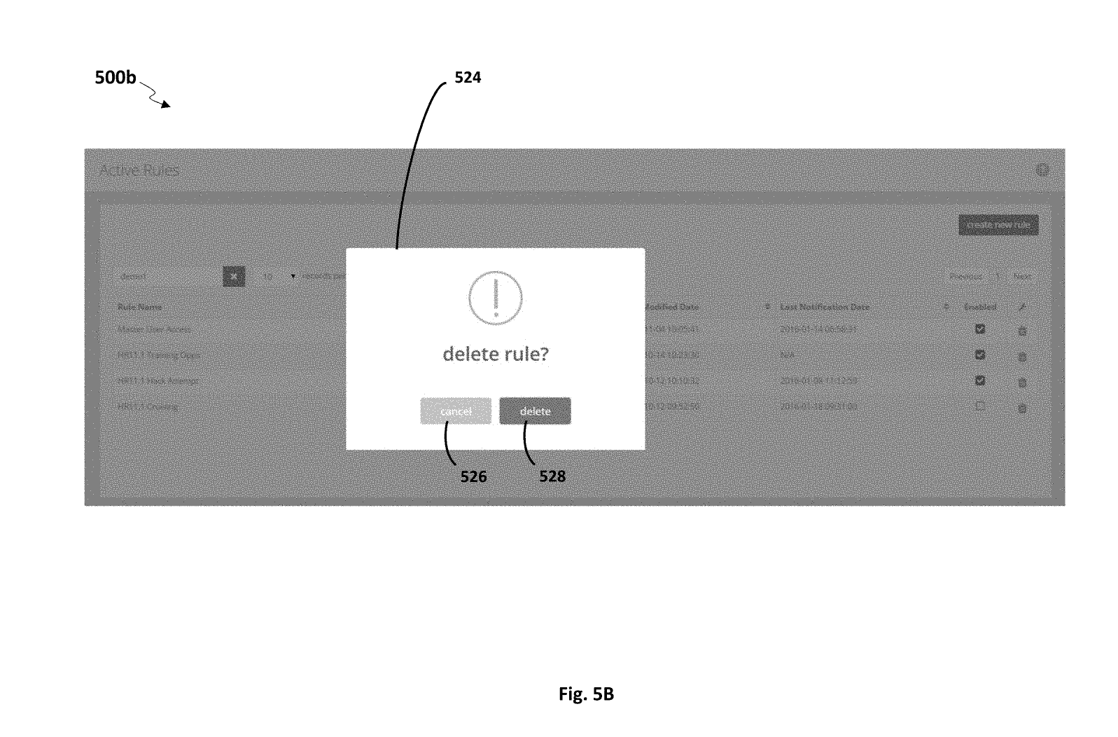

Some embodiments include a system for generating user interfaces, as illustrated in FIGS. 5A, 5B, 6, 7, and 8 on authorized user devices and designated recipient devices. The system includes an event management database; one or more processors communicatively coupled to the event management databases and an event management engine with non-transitory computer-readable medium positioned in communication with the one or more processors and having a computer program stored thereon including a set of instructions. The instructions when executed by one or more processors may cause the one or more processors to perform operations of receiving from an authorized device of an enterprise resource planning system a plurality of criteria defining a rule stored as a first plurality of records in the event management database. For example, when user login credentials are received via an electronic communication network from an authorized computing device in the ERP system, the event management engine compares these credentials against the records in the event management database and verifies the user login credentials as those of an authorized user. Then, the event management engine may generate user interfaces on the computing device where the authorized user login credentials were provided via electronic communication network 104. The event management engine may present one of several user interfaces on the computing device, such as in a web browser or via an application interface where the authorized user may be presented with options for creating new rules, accessing previously created rules, and/or managing rules in the event management database on the enterprise resource planning system.

FIG. 5A is an illustrative user interface 500a for managing rules, according to an exemplary embodiment. In some embodiments, graphical user interfaces generated may include various controls that operate different functions of the application. Such controls may include, for example, icons, texts, buttons, input boxes, menus, drop-down lists, sliders, scroll bars, bars and/or any other operable visual element. Control of the functions may also be embodied in one or more physical buttons and not as part of the user interface of the event management system itself. For example, a certain button such as the “create new rule” button may be used to perform specific functions and interact with the interface. A user may launch a process to create a new rule by clicking on the button 501 titled, “create new rule.” The interface 500a may also provide the user with a list of already existing rules. These rules may be arranged in the form of a table with column headers such as the rule name 502, subscribed users 508, time stamp showing last modified date 514, last notification date 516, and an enabled option 518, enabling selection of whether the notification is enabled. For example, in the illustrative interface there are two rules: Master User Access rule 504 and HR11.1 Training Opps. rule 506. Each of the rules is associated with specific users, whose identifying information may be displayed under the column header 508 titled, “Subscribed Users,” such as e-mail information 510 of the individual. Certain embodiments include a notification sent as an alert within another software application, including content shown on a website. The illustrative user interface also shows that the rule “HR11.1 Cruising” is not enabled, 520. Lastly, the trash can icons in the interface, 522, may be used to delete a rule.

When any of the trash can icons, 522, are clicked, the user may be presented with a confirmation user interface, 500b, shown in FIG. 5B. The dialog element, 524, may ask the user to either cancel the deletion of the rule, 526, or confirm the action by pressing delete, 528, as desired by the user. The user may then be returned to interface 500b. This illustrative user interface 500b of a rule composer module may also be presented for deleting unwanted rules, according to an exemplary embodiment. The system may also be set such that only authorized users are provided with options to delete the existing rules.

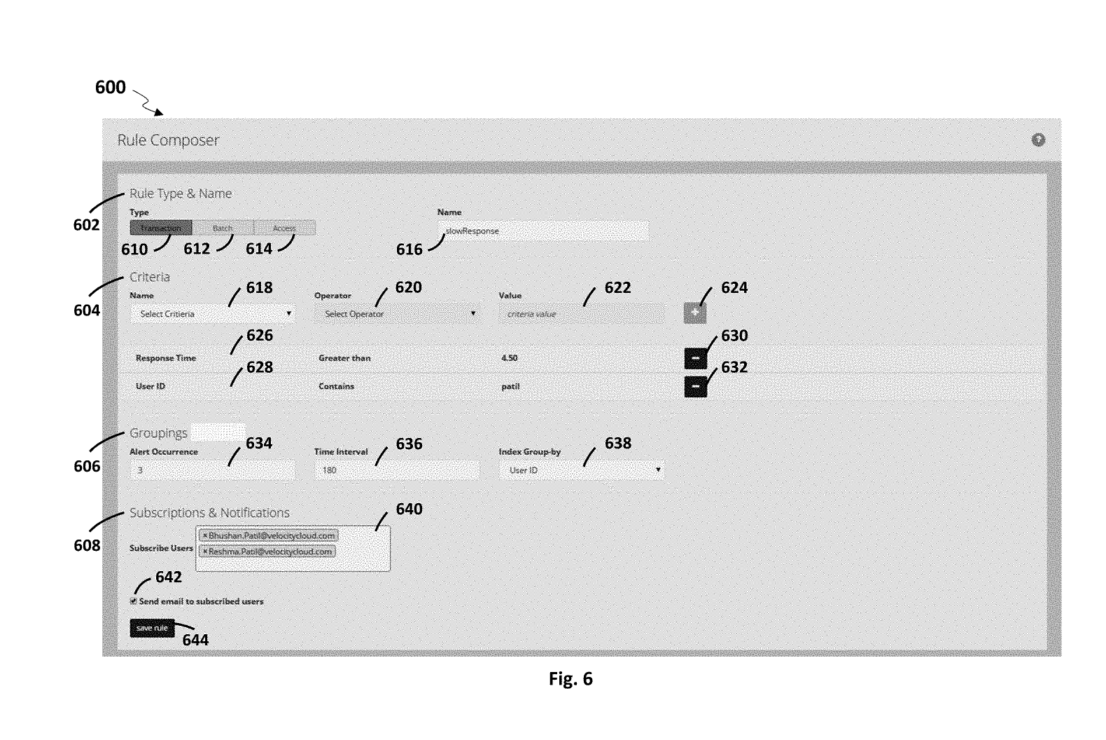

FIG. 6 is an illustrative user interface 600 that is presented to a user to create new rules, according to an exemplary embodiment. For example, when user login credentials are received via an electronic communication network 104 from an authorized computing device in the ERP system, the event management engine compares these credentials against the records in the event management database and verifies the user login credentials as those of an authorized user. Then, the event management engine may generate user interfaces on the computing device where the authorized user login credentials were provided via an electronic communication network. The event management engine may present a user interface on the computing device such as in a web browser or via an application interface where the authorized user is presented with options for creating new rules.

Illustrative user interface 600 is an example of the rule composer module. Embodiments of the work flow of the user interface include the following. In section 602 titled, “Rule Type & Name,” the user may be presented with options for creating different types of rules. Clickable button 610 titled, “Transaction,” is an example for creating rules based on transactions executed in the ERP system. Clickable button 612 titled, “Batch,” is another example for creating rules to be executed on batches in the ERP system. Clickable button 614 titled, “Access,” is yet another example for creating rules based on user access of the ERP system. In illustrative user interface 600, the user has selected a Transaction rule type. A user may then provide a name for the rule by entering text in the Name field 616. In this example, the user has given the rule the name “slowResponse.” The user may then move onto section 604 titled, “Criteria.” The interface guides the user in adding criteria in grouping 604. The user is presented with a row of criteria elements that are selected in order from the drop down select boxes to define a criterion for the rule. The elements may include Criteria Name 618, Criteria Operator 620, and Criteria Value 622. The content of the drop down select box Criteria Name, 618, is populated and enabled upon rule type selection. The content of drop down select box Criteria Operator, 620, is populated and enabled upon criteria name selection. The input field Criteria Value, 622, is enabled upon operator selection. Once a complete criterion is defined, the Add button, 624, is enabled. Clicking the Add button, 624, pushes the criterion as defined into the criteria table below the selectors. In this instance, the two criteria have been set for the rule, Response Time, 626, with operator greater than 4.50 seconds, and User ID, 628, with operator contains the string “patil”. Delete buttons 630 and 632, are enabled that would remove criterion, 626 and 628 respectively, from the rule.

FIG. 6 as an illustrative user interface continues with the user selecting desired grouping of events in section 606 labeled “Groupings” in the exemplary embodiment. This interface is generated when the user selects the menu item 606 titled, “Groupings.” The user is presented with options to include other constraints such as time box event configurations, such as number of occurrences 634 and time interval 636 and grouping of events by any criteria name, 638. In this example, the user has defined a time interval constraint 636 with a fillable value of 180 seconds and alert occurrences 634 at 3. In addition, the user is grouping these events by User ID in element 638. The list of subscribed users for the rule are defined in section 608 by entering email addresses into the text field 640. In other embodiments, the subscribe user list may be a fillable field or can be chosen from existing users presented as a drop-down menu. This list is populated here with the email address for an individual, but in other embodiments, the list could be populated by user names, telephone numbers, or any other personal identifiers, such as employee ID. In this exemplary embodiment, the subscribed users are notified by a web application. To include an email notification upon an alert, the user selects the check box, 642, “Send email to subscribed users.” There could also be an option to communicate to subscribed users via text message or mobile application. Lastly, the user selects “save rule” button 644, which submits this rule to the notification engine. Standard navigation controls to move between different interfaces are provided as buttons, for example without limitation. Upon selecting ‘save rule’, 644, the user is redirected to illustrative user interface 500a shown in FIG. 5A, where the newly created rule will be visible. In certain embodiments, this interface is generated when the user selects the menu item titled, “Finish.” The user is presented with options to include a Rule Name in the form of a fillable field or a drop-down menu. The user also has options to provide a description in the fillable field. Standard navigation controls to move between different interfaces are provided as buttons, for example without limitation, a button that navigates the user to a previous screen, while buttons that direct the user to processes to finish the rule composer module or to cancel the attempt.

In an embodiment, when user login credentials are received via an electronic communication network from an authorized computing device in the ERP system, an event management engine may compare these credentials against the records in the event management database and verify the user login credentials to be those of a designated recipient. The event management engine may then generate user interfaces on that recipient computing device where the designated recipient credentials were provided via an electronic communication network. The event management engine may present one of several user interfaces on the recipient computing device such as a web browser or an application interface, where the designated recipient may be presented with options for reviewing new or previously received notifications in the event management database on the enterprise resource planning system. In another embodiment, the notification received from the event management engine on the designated recipient device may include a link to an interface where the event management engine presents further details about the notification.

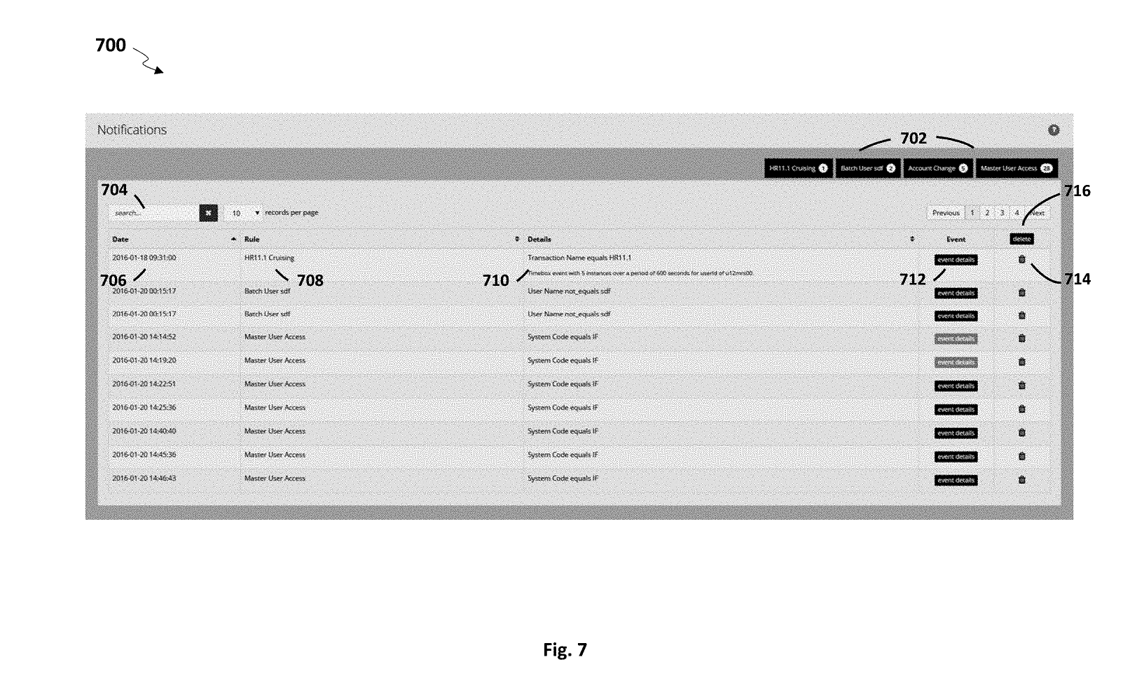

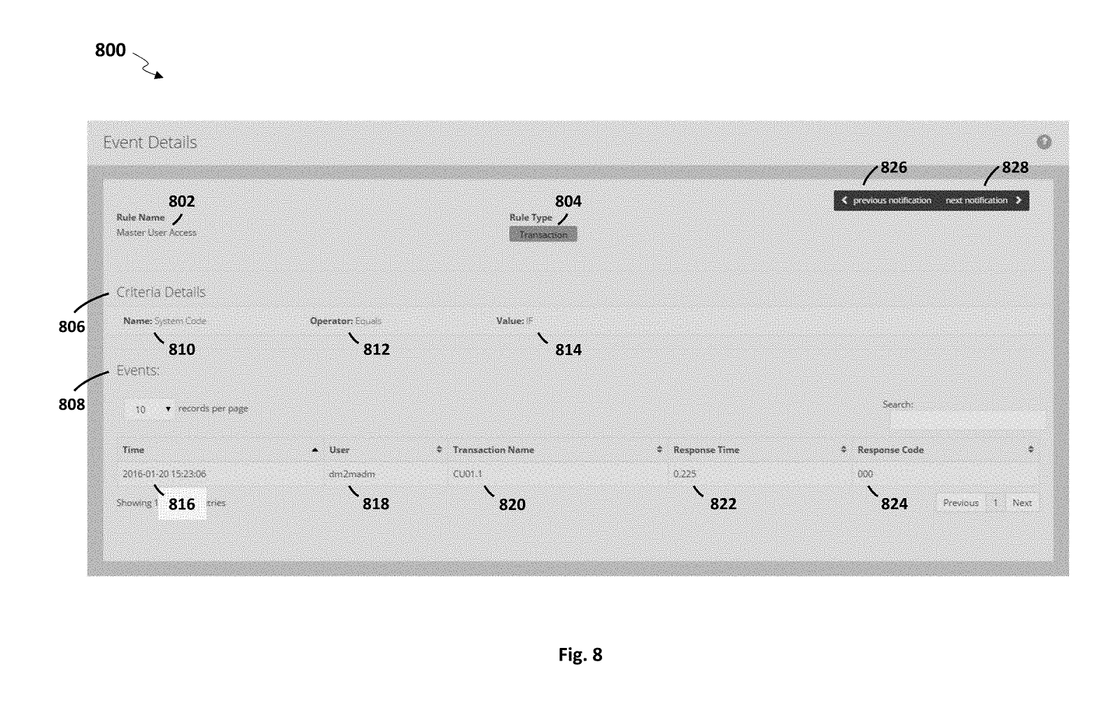

FIG. 7 is an illustrative user interface 700 of a notification inbox on a designated recipient device, according to an exemplary embodiment. The user interface 700 presents the details to a designated recipient regarding the notifications, when the recipient device is logged into, or is in communication with the system. For example, the rules that have been executed may be identified by rule each with a count value such as clickable buttons 702. The user interface also allows the user to search by selecting a clickable button 702, or entering text in the search box 704. The user may search through the various instances when the notification was triggered by presenting the information in the form of a table as illustrated, with column headings such as Date 706, Rule 708, Details 710, Event 712 and trashcan 714. Rule 708 may identify a rule that was executed. Details 710 may present details for a summary of the rule criteria. Event 712 may provide a link to user interface as illustrated in FIG. 8. Trashcan, 714 may be selected for deletion of the event and the column header with delete button 716, which will delete all selected notifications. In the top row of the example provided, at a particular time from Date 706 on Jan. 18, 2016, a notification regarding the “HR11.1 Cruising” Rule 712 was sent to the designated recipient. This rule can be described with the short description in Details 710 stating “Transaction Name equals HR11.1.” The user is presented with options to view each of the events in detail as illustrated in interface 800 by clicking or selecting button 712. Standard navigation controls are provided as buttons or links, to control movement between different interfaces.

FIG. 8 is an illustrative user interface 800 of the notification event details on a designated recipient device, according to an exemplary embodiment. The interface 800 presents the details of the ERP system events which satisfied the criteria of the rule 802 of rule type 804. The matching criteria at the time of the event are stated in section 806 labeled “Criteria Details” are shown in row(s) as per 810, 812 and 814. The triggering event(s) are listed in tabular format in section 808 labeled “Events:” in tabular format showing the Time 816, User 818, Transaction Name 820, Response Time 822, and Response Code 824. The set of columns in user interface 800 are specific to the rule type. The user is able to navigate through different notifications as per they are listed in user interface 700 using controls 826 and 828 with labels “previous notification” and “next notification” respectively.

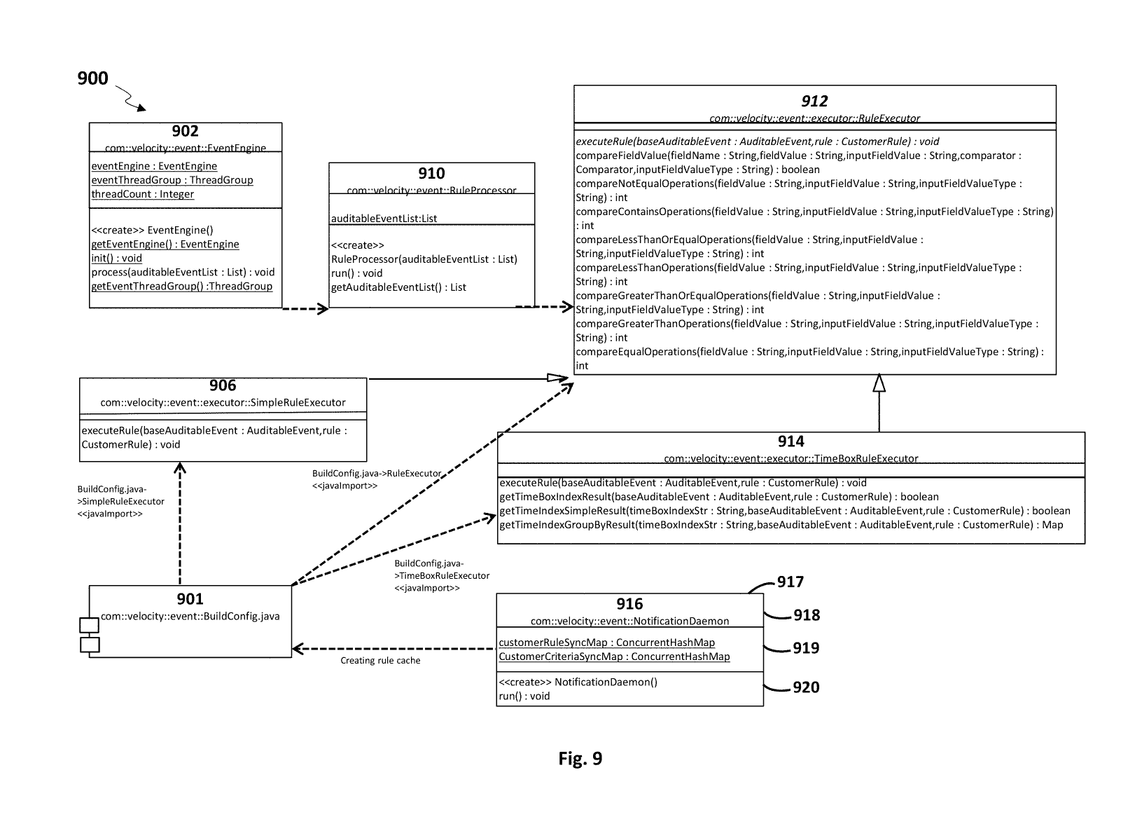

FIG. 9 is an illustrative class diagram 900 presenting a high level view of the different software modules/packages that collectively perform the event management functions, according to an exemplary embodiment. The diagram 900 shows object interactions arranged in a time sequence and includes the buildConfig.java 901, EventEngine 902, Rule Processor 910, RuleExecutor 912, SimpleRuleExecutor 906, TimeBoxRuleExecutor 914, and NotificationDaemon 916 classes or objects. The two classes, RuleExecutor 912 and SimpleRuleExecutor 906, are hierarchically superior classes. EventEngine 902 is associated with Rule Processor 910 that is subsequently associated with and feeds into the RuleExecutor 912. Events are also processed through RuleExecutor 912, SimpleRuleExecutor 906, and TimeBoxRuleExecutor 914. Further, a specific class, for example the NotificationDaemon 916, is represented in the UML class diagram 900 as a rectangle 917 with three compartments 918, 919, and 920. The first compartment 918 shows the class name “NotificationDaemon,” the second compartment 919 shows the class attribute(s) (i.e. structure), and the third compartment 920 methods performed by that class (i.e. behavior).

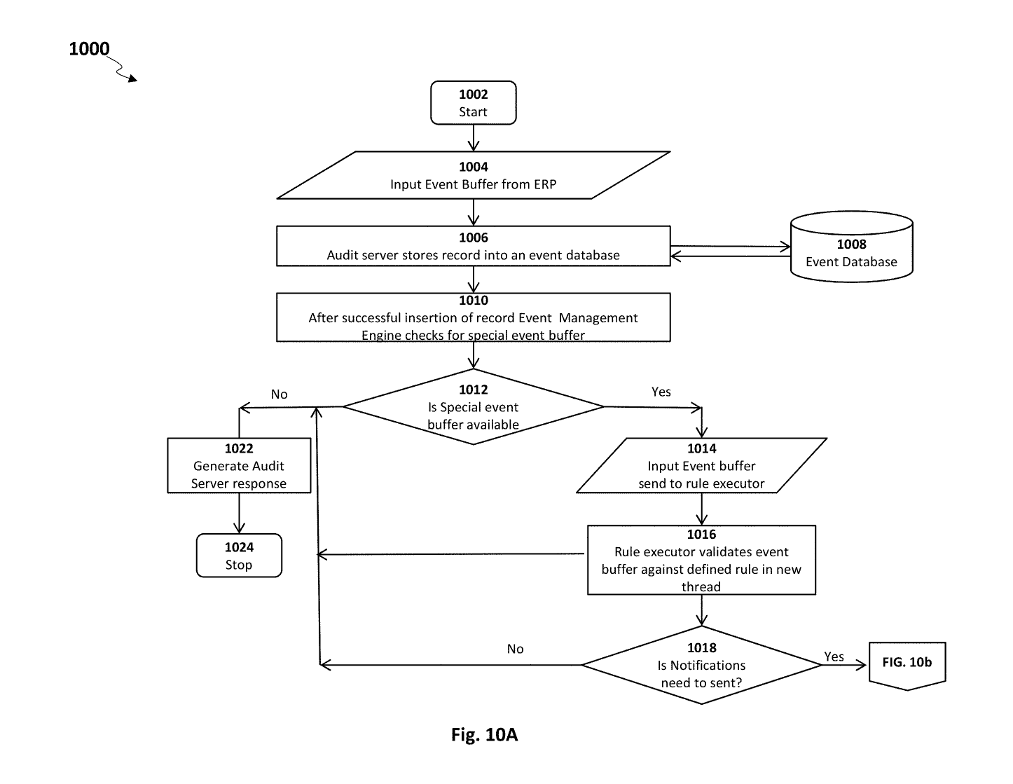

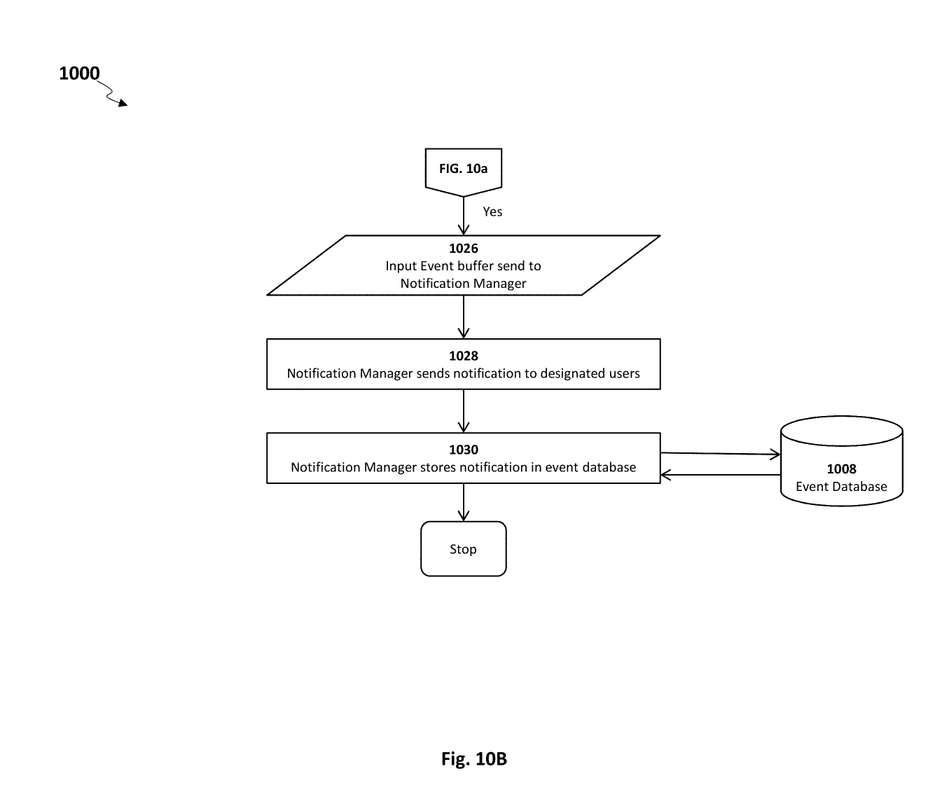

FIGS. 10A and 10B form a continuous flowchart illustrating an event management process, according to an exemplary embodiment 1000. The process may begin in step 1002 and proceed with an event buffer from an ERP system being inputted into the event management system in step 1004. The system may proceed to step 1006 where the event buffer may be made available to an audit server module that inserts the records into an event database in step 1008. After successful insertion of the record, the event management engine may check for the special event buffer in step 1010. At this point, when a determination in step 1012 is made that a special event buffer exists, then the input event buffer may be sent to a rule executor module in step 1014. The rule executor may validate the event buffer against applicable defined rules in a new thread and either redirects it to the path to generate an appropriate response from the audit server in step 1022 or send it to evaluate if notifications should be sent in step 1018. When notifications do not need to be sent, then it is redirected to generate an appropriate response from the audit server in step 1022 and the process may end in step 1024. When notifications need to be sent to designated recipients, the systems may proceed to part of the process described in FIG. 10B. The input event buffer may be sent to a notification manager or a notification management module in step 1026. In a next step 1028, the notification manager may send notifications in a preferred format to a preferred device of a designated recipient. The notification manager may be configured to send alerts in different formats, such as texts, e-mail, app notifications, web hyperlinks, and such to one or more devices, such as smartphones, tablets, and other computing and communication devices. The notification manager may store the data and metadata associated with the notification in step 1030 in event database 1008. The computer software described herein may be executed on one computer or on several computers that are networked together.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware may be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular. The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of detecting events in an enterprise resource planning system, the method comprising:
receiving, by a server, from an authorized device of an enterprise resource planning system a plurality of criteria defining a rule and stored as a first plurality of records in an event management database, wherein the plurality of criteria were selected by a user via a rule composition graphical user interface that presents a rule type option comprising transaction, batch, and access, and the plurality of criteria comprise name, operator, and value;
receiving, by the server, a plurality of information associated with a first plurality of events occurring at a plurality of user devices in the enterprise resource planning system, wherein each event comprises an instance of a data transaction;
filtering, by the server, the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule;
retrieving, by the server, from the event management database in response to identifying the second plurality of events a second plurality of records defining a notification profile associated with the rule, wherein the notification profile includes one or more preferences for notification format, and one or more designated recipient devices;
formatting, by the server, the one or more of the plurality of information associated with the second plurality of events to generate one or more notifications based on the notification profile; and
transmitting, by the server, the one or more notifications to the one or more designated recipient devices to present a first notification of the one or more notifications via the graphical user interface wherein the first notification includes a date, the rule, and event details for each event of the second plurality of events, wherein selecting the event details presents an event details graphical user interface.

2. The method of claim 1, wherein the transaction type of rule creates a rule for transactions that are executed in the enterprise resource planning system.

3. The method of claim 2, wherein the batch type of rule creates a rule to be executed on batches in the enterprise resource planning system.

4. The method of claim 3, wherein the access type of rule creates a rule for user access of the enterprise resource planning system.

5. The method of claim 1, wherein the event details graphical user interface displays a rule name and rule type.

6. The method of claim 5, wherein the event details graphical user interface further comprises presenting the name, the operator and the value of the criteria for the rule. The method of claim 6, wherein the event details graphical user interface further presents each of the second plurality of events.

8. The method of claim 7, wherein the event details graphical user interface further presents a time, a user identifier, a transaction name, a response time, and a response code for the event.

9. A system for detecting events in an enterprise resource planning system, the system comprising:
an event management database;
a processor communicatively coupled to the event management database, the processor configured to:
receive from an authorized device of an enterprise resource planning system a plurality of criteria defining a rule and stored as a first plurality of records in an event management database, wherein the plurality of criteria were selected by a user via a rule composition graphical user interface that presents a rule type option comprising transaction, batch, and access, and the plurality of criteria comprise name, operator, and value;
receive a plurality of information associated with a first plurality of events occurring at a plurality of user devices in the enterprise resource planning system, wherein each event comprises an instance of a data transaction;
filter the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule;
retrieve from the event management database in response to identifying the second plurality of events a second plurality of records defining a notification profile associated with the rule, wherein the notification profile includes one or more preferences for notification format, and one or more designated recipient devices;
format the one or more of the plurality of information associated with the second plurality of events to generate one or more notifications based on the notification profile; and
transmit the one or more notifications to the one or more designated recipient devices to present a first notification of the one or more notifications via the graphical user interface wherein the first notification includes a date, the rule, and event details for each event of the second plurality of events, wherein selecting the event details presents an event details graphical user interface.

10. The system of claim 9, wherein the transaction type of rule creates a rule for transactions that are executed in the enterprise resource planning system.

11. The system of claim 10, wherein the batch type of rule creates a rule to be executed on batches in the enterprise resource planning system.

12. The system of claim 11, wherein the access type of rule creates a rule for user access of the enterprise resource planning system.

13. The system of claim 9, wherein the event details graphical user interface displays a rule name and rule type.

14. The system of claim 13, wherein the event details graphical user interface further comprises presenting the name, the operator and the value of the criteria for the rule.

15. The system of claim 14, wherein the event details graphical user interface further presents each of the second plurality of events.

16. The system of claim 15, wherein the event details graphical user interface further presents a time, a user identifier, a transaction name, a response time, and a response code for the event.

17. A computer-readable storage medium storing instructions that, when executed by a computing system, cause the computing system to perform operations for a method of detecting events in an enterprise resource planning system, the operations comprising:
receiving, by a server, from an authorized device of an enterprise resource planning system a plurality of criteria defining a rule and stored as a first plurality of records in an event management database, wherein the plurality of criteria were selected by a user via a rule composition graphical user interface that presents a rule type option comprising transaction, batch, and access, and the plurality of criteria comprise name, operator, and value;
receiving, by the server, a plurality of information associated with a first plurality of events occurring at a plurality of user devices in the enterprise resource planning system, wherein each event comprises an instance of a data transaction;
filtering, by the server, the first plurality of events to identify a second plurality of events by comparing the plurality of information associated with the first plurality of events with all of the plurality of criteria associated with the rule, wherein one or more of the plurality of information associated with the second plurality of events satisfies all of the plurality of criteria associated with the rule;
retrieving, by the server, from the event management database in response to identifying the second plurality of events a second plurality of records defining a notification profile associated with the rule, wherein the notification profile includes one or more preferences for notification format, and one or more designated recipient devices;
formatting, by the server, the one or more of the plurality of information associated with the second plurality of events to generate one or more notifications based on the notification profile; and
transmitting, by the server, the one or more notifications to the one or more designated recipient devices to present a first notification of the one or more notifications via the graphical user interface wherein the first notification includes a date, the rule, and event details for each event of the second plurality of events, wherein selecting the event details presents an event details graphical user interface.

18. The computer-readable storage medium according to claim 17, wherein the transaction type of rule creates a rule for transactions that are executed in the enterprise resource planning system.

19. The computer-readable storage medium according to claim 18, wherein the batch type of rule creates a rule to be executed on batches in the enterprise resource planning system.

20. The computer-readable storage medium according to claim 19, wherein the access type of rule creates a rule for user access of the enterprise resource planning system.
